(19) United States
(12) Patent Application Publication
(10) Pub. No.: US 2022/0164928 A1
(43) Pub. Date: May 26, 2022

(54) IMAGE PROCESSING APPARATUS, IMAGE PROCESSING METHOD, AND PROGRAM

(71) Applicant: SONY GROUP CORPORATION, TOKYO (JP)

(72) Inventors: HARUKA MITSUMORI, TOKYO (JP); NORIAKI TAKAHASHI, TOKYO (JP); TAKAAKI SUZUKI, TOKYO (JP); YUTO KOBAYASHI, TOKYO (JP)

(21) Appl. No.: 17/441,163

(22) PCT Filed: Mar. 17, 2020
(86) PCT No.: PCT/JP2020/011583

§ 371 Date: Sep. 20, 2021

(30) Foreign Application Priority Data
Mar. 29, 2019 (JP) 2019-066429

(51) Int. Cl. G06T 5/00; G06T 7/80; G06T 5/50

(52) U.S. Cl. CPC G06T 5/006; G06T 5/50; G06T 7/80; G06T 5/003

(57) ABSTRACT

The present disclosure relates to an image processing apparatus, an image processing method, and a program that are capable of correcting and displaying a multi-viewpoint image so that the multi-viewpoint image can be appropriately viewed. On multi-viewpoint images to be projected, geometrical correction is performed, blurring correction is performed, and by using the viewpoint images subjected to the geometric correction and the blurring correction, crosstalk correction is performed on the basis of each diffusion distribution. The present disclosure can be applied to a display device of a multi-viewpoint image.

### TECHNICAL FIELD

The present disclosure relates to an image processing apparatus, an image processing method, and a program, and particularly relates to an image processing apparatus, an image processing method, and a program that are capable of correcting and displaying a multi-viewpoint image so that the multi-viewpoint image can be appropriately viewed.

### BACKGROUND ART

In recent years, a technology for displaying a multi-viewpoint image in which different images are viewed from a plurality of viewpoints, such as a 3D image, has been generally spread.

As the technology for displaying a multi-viewpoint image, there are a technology using a projector array and a diffuser, and a technology using a parallax barrier, a lenticular lens, and the like, and in either technology, calibration according to a viewing position is required.

As a calibration technology of a 3D display system using a microlens array (lenticular lens) and a liquid crystal display (LCD), a technology has been proposed in which a shift amount of a lens array from an ideal installation position is detected by displaying a calibration pattern and capturing an image of the calibration pattern by a camera, and a display image is corrected by calculating a correction amount (refer to Patent Document 1).

### CITATION LIST

### Patent Document

Patent Document 1: JP 2009-276410 A

### SUMMARY OF THE INVENTION

### Problems to be Solved by the Invention

However, in the technology of Patent Document 1, only a position of a pixel that emits a light beam passing through a lens principal point of a microlens is calculated, and information indicating that light is leaking also from a light beam of a peripheral pixel is not used for image generation, and it is considered that mixing of viewpoint images occurs.

In addition, since the shift amount of the installation position of the lens array is calculated instead of directly obtaining the correction amount of the display image, it is necessary to perform calculation in the middle of processing, such as estimation of a camera position with accuracy equivalent to that of installation of the lens array.

The present disclosure has been made in view of such a situation, and particularly corrects and displays a multi-viewpoint image so that the multi-viewpoint image can be appropriately viewed.

### Solutions to Problems

An image processing apparatus according to one aspect of the present disclosure is an image processing apparatus including: a projection unit that projects multi-viewpoint images; a geometric correction unit that performs geometric correction on the multi-viewpoint images; and a crosstalk correction unit that performs crosstalk correction on the multi-viewpoint images.

An image processing method and a program according to one aspect of the present disclosure correspond to the image processing apparatus according to one aspect of the present disclosure.

In one aspect of the present disclosure, multi-viewpoint images are projected, geometric correction is performed on the multi-viewpoint images, and crosstalk correction is performed on the multi-viewpoint images.

### BRIEF DESCRIPTION OF DRAWINGS

FIG. 1 is a diagram illustrating a configuration example of an image processing system of the present disclosure.

FIG. 2 is a diagram illustrating a detailed configuration example of the image processing system.

FIG. 3 is a diagram illustrating gray code test patterns.

FIG. 4 is a diagram illustrating a test pattern of one pixel pattern.

FIG. 5 is a diagram illustrating how to obtain a point spread function (PSF).

FIG. 6 is a diagram illustrating how to obtain a diffusion distribution.

FIG. 7 is a diagram illustrating how to obtain the diffusion distribution.

FIG. 8 is a diagram illustrating a detailed configuration example of a correction unit in an image display unit.

FIG. 9 is a diagram illustrating crosstalk correction.

FIG. 10 is a diagram illustrating the crosstalk correction.

FIG. 11 is a diagram illustrating the crosstalk correction.

FIG. 12 is a diagram illustrating correction using a plurality of correction parameters.

FIG. 13 is a flowchart illustrating correction parameter calculation processing.

FIG. 14 is a flowchart illustrating display processing.

FIG. 15 is a diagram illustrating an application example of the correction using a plurality of correction parameters.

FIG. 16 is a flowchart illustrating blurring correction processing.

FIG. 17 is a flowchart illustrating display processing in the application example of the correction using a plurality of correction parameters.

FIG. 18 is a diagram illustrating a configuration example of a general-purpose personal computer.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference signs, and redundant description is omitted.

Hereinafter, modes for carrying out the present technology will be described. The description will be given in the following order.

1. Preferred Embodiment

2. Application Example

3. Example of Executing Processing by Software

### 1. Preferred Embodiment

### <Configuration Example of Image Processing System of Present Disclosure>

The present disclosure corrects a multi-viewpoint image so that the multi-viewpoint image can be appropriately viewed.

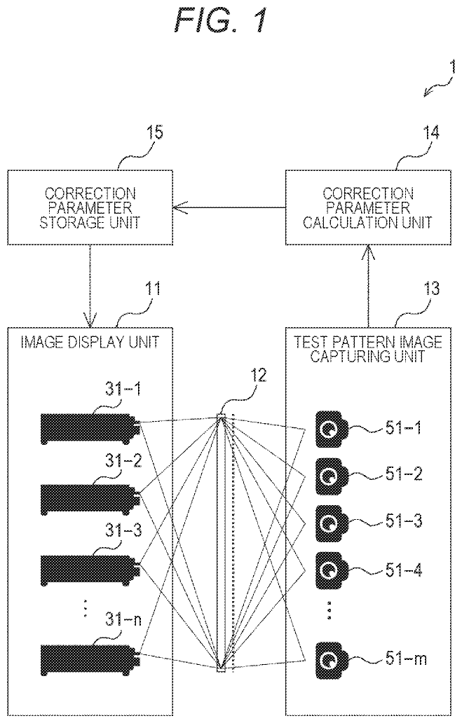

FIG. 1 illustrates a configuration example of an image processing system to which the present disclosure is applied.

An image processing system 1 of FIG. 1 includes an image display unit 11, a directional screen 12, a test pattern image capturing unit 13, a correction parameter calculation unit 14, and a correction parameter storage unit 15.

The image display unit 11 includes a projector array and a liquid crystal display (LCD), and displays a multi-viewpoint image.

FIG. 1 illustrates an example of the image display unit 11 including a projector array, in which display units 31-1 to 31-n including projectors are arranged in an array in a horizontal direction, and the display units 31-1 to 31-n display images from n directions.

Note that, hereinafter, the display units 31-1 to 31-n will be simply referred to as display units 31 in a case where it is not particularly necessary to distinguish the display units 31-1 to 31-n from each other, and other configurations will be similarly referred to.

The directional screen 12 includes a lenticular lens, a parallax barrier, and a diffuser, and transmits the images on the display units 31-1 to 31-n from the n directions in a state where the images can be viewed as multi-viewpoint images having directivity in each predetermined direction.

The test pattern image capturing unit 13 includes cameras 51-1 to 51-m installed according to viewing positions, captures, at each viewpoint position, an image in which a test pattern is displayed by the image display unit 11 and which is transmitted through the directional screen 12, and outputs an image capturing result to the correction parameter calculation unit 14.

The correction parameter calculation unit 14 calculates, on the basis of an image captured for each viewpoint position by the test pattern image capturing unit 13, correction parameters for correcting an image projected by the image display unit 11, and stores the correction parameters in the correction parameter storage unit 15.

More specifically, the correction parameters are a geometric correction vector, a point spread function (PSF) representing a blurring amount, and a diffusion distribution.

The image display unit 11 reads correction parameters stored in the correction parameter storage unit 15, and corrects display on each display unit 31 on the basis of the read correction parameters.

With the series of configurations described above, in addition to correction of an image in each viewpoint unit according to a geometric correction vector and a blurring amount, it is possible to perform correction on the basis of a diffusion distribution so as to reduce an influence of crosstalk occurring between images viewed at adjacent viewpoint positions, and it is possible to achieve appropriate viewing of a multi-viewpoint image.

### <Detailed Configuration Example of Image Processing System>

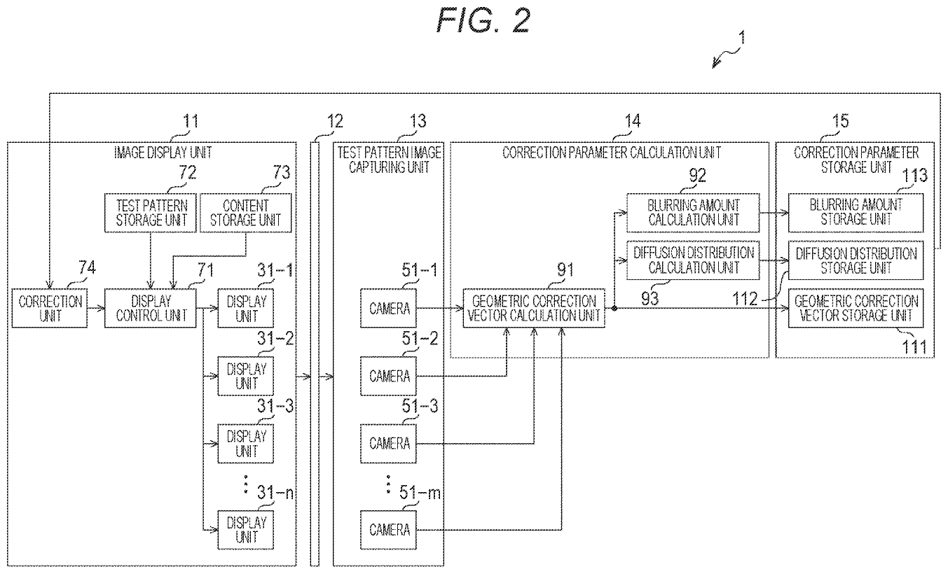

Next, a detailed configuration example of the image processing system 1 of FIG. 1 will be described with reference to FIG. 2. FIG. 2 illustrates a detailed configuration example of the image display unit 11, the test pattern image capturing unit 13, the correction parameter calculation unit 14, and the correction parameter storage unit 15 that constitute the image processing system 1.

The image display unit 11 includes, in addition to the display units 31-1 to 31-n that display images of respective viewpoints, a display control unit 71, a test pattern storage unit 72, a content storage unit 73, and a correction unit 74.

The display control unit 71 includes a processor and a memory, and controls an entire operation of the image display unit 11.

In addition, the display control unit 71 controls the correction unit 74 to correct image data to be a content in display processing to be described later on the basis of a correction parameter generated by correction parameter generation processing to be described later, and causes the display units 31-1 to 31-n to display the image data as multi-viewpoint images.

The test pattern storage unit 72 includes a hard disc drive (HDD), a solid state drive (SSD), and a semiconductor memory, stores image data of a test pattern, and supplies the image data to the display control unit 71 as necessary.

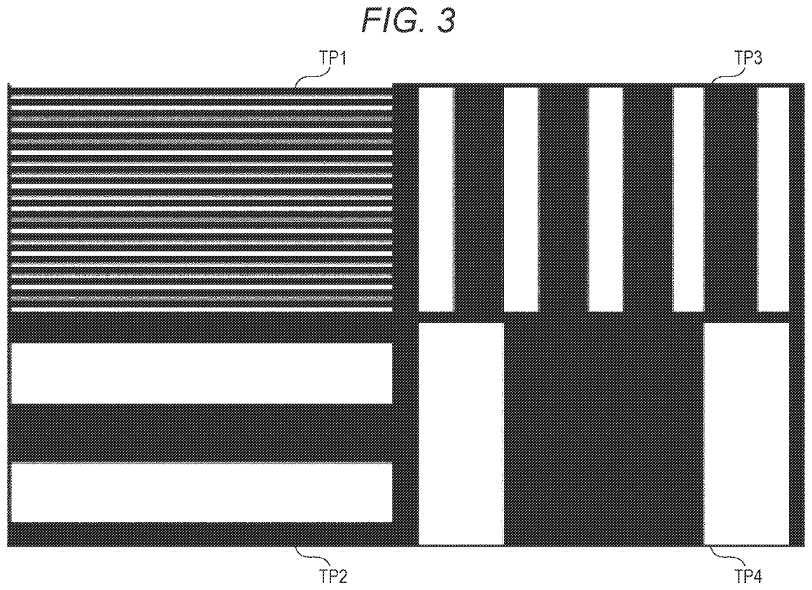

The test pattern is, for example, an image including structured light such as a gray code as indicated by images TP1 to TP4 illustrated in FIG. 3, that is, an image in which pixel positions of white pixels and black pixels in the image are known in advance.

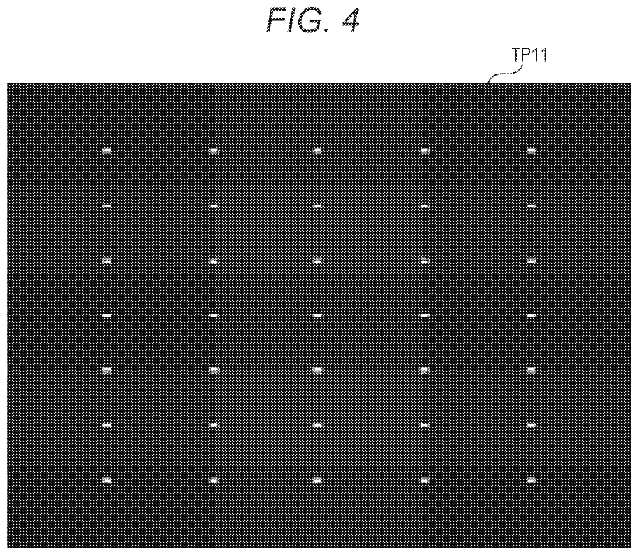

In addition, the test pattern also includes an image TP11 including point light sources in one pixel unit arranged at equal intervals, as illustrated in FIG. 4.

Moreover, in addition to the images TP1 to TP4 of FIG. 3 and the image TP11 of FIG. 4, the test pattern also includes an all-white image in which all pixels are white and an all-black image in which all pixels are black.

As the test pattern, the images TP1 to TP4 of FIG. 3, the image TP11 of FIG. 4, the image in which all pixels are white, and the image in which all pixels are black are sequentially switched and displayed.

The content storage unit 73 includes a hard disc drive (HDD), a solid state drive (SSD), and a semiconductor memory, stores image data of a content including multi-viewpoint images, and supplies the image data to the display control unit 71 as necessary.

That is, in the correction parameter generation processing to be described later, the display control unit 71 reads image data of a test pattern stored in the test pattern storage unit 72, supplies the image data to the display units 31-1 to 31-n, and causes the display units 31-1 to 31-n to display the image data.

At this time, the display control unit 71 causes the display units 31-1 to 31-n to display the test pattern without correction performed by the correction unit 74. With this configuration, a multi-viewpoint image in an uncorrected state is displayed, and a correction parameter required for correction is calculated on the basis of a correspondence relationship between a pixel displayed at a pixel position at which the pixel is originally to be displayed and a pixel actually displayed.

In addition, in the display processing to be described later, the display control unit 71 reads image data of a content including multi-viewpoint images, which is stored in the content storage unit 73, supplies the image data to the display units 31-1 to 31-n, and causes the display units 31-1 to 31-n to display the image data.

At this time, the display control unit 71 controls the correction unit 74 to correct the image data of the content on the basis of a correction parameter stored in the correction parameter storage unit 15, supplies the image data to the display units 31-1 to 31-n, and causes the display units 31-1 to 31-n to display the image data as multi-viewpoint images.

That is, in the display processing, the display control unit 71 controls the correction unit 74 to correct the image data of the content on the basis of a correction parameter generated in advance by the correction parameter generation processing, supplies the image data to the display units 31-1 to 31-n, and causes the display units 31-1 to 31-n to display the image data as corrected multi-viewpoint images.

With this configuration, a multi-viewpoint image in an appropriately corrected state is displayed, so that it is possible to achieve appropriate viewing of the multi-viewpoint image.

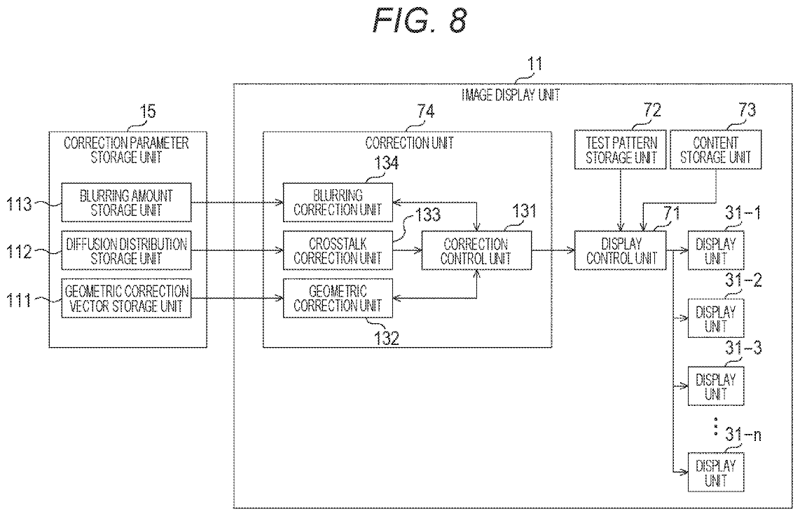

Note that a detailed configuration of the correction unit 74 will be described later with reference to FIG. 8.

The test pattern image capturing unit 13 includes the cameras 51-1 to 51-m installed at a large number of viewpoint positions with respect to the directional screen 12, captures images of test patterns displayed by the image display unit 11 via the directional screen 12, and outputs the images to the correction parameter calculation unit 14.

The correction parameter calculation unit 14 acquires an image of a test pattern captured at a viewpoint position of each of the cameras 51-1 to 51-m of the test pattern image capturing unit 13, calculates a correction parameter on the basis of the acquired image of the test pattern, and causes the correction parameter storage unit 15 to store the correction parameter.

More specifically, the correction parameter calculation unit 14 includes a geometric correction vector calculation unit 91, a blurring amount calculation unit 92, and a diffusion distribution calculation unit 93.

By comparing an image of an original test pattern with images captured by the cameras 51-1 to 51-m from respective viewpoint positions, the geometric correction vector calculation unit 91 generates a geometric correction vector on the basis of a positional relationship between a pixel actually captured in a captured image and a pixel to be captured.

Then, the geometric correction vector calculation unit 91 outputs the generated geometric correction vector to each of the blurring amount calculation unit 92, the diffusion distribution calculation unit 93, and the correction parameter storage unit 15.

At this time, the geometric correction vector calculation unit 91 further outputs an image of a test pattern supplied from each of the cameras 51-1 to 51-m to the blurring amount calculation unit 92 and the diffusion distribution calculation unit 93.

The geometric correction vector is, for example, a vector starting from each pixel in an image actually captured by the camera 51 and ending at a pixel to be originally captured (to be originally viewed) at a corresponding pixel position (the ending point and the starting point may be opposite), and is obtained for all pixels.

On the basis of the geometric correction vector, pixel arrangement of each of the display units 31-1 to 31-n of the image display unit 11 is replaced and displayed, whereby geometric arrangement of pixels of an image viewed at a viewpoint position of each of the cameras 51-1 to 51-m can be corrected.

That is, an image of a test pattern displayed by each of the display units 31-1 to 31-n should originally be viewed at each viewpoint position as an image of an original test pattern by each of the cameras 51-1 to 51-m of the test pattern image capturing unit 13.

However, in reality, an image different from an actual test pattern is projected due to optical characteristics or the like.

That is, each pixel is moved to a pixel position different from a pixel position at which each pixel of the original test pattern is originally to be projected, and projected, so that the entire image is projected in a state in which distortion occurs geometrically.

Thus, the geometric correction vector calculation unit 91 compares an image of a known test pattern with an actually captured image of a test pattern, and obtains, for all pixels, a correspondence relationship between a position of a pixel that is geometrically shifted and viewed and a pixel that is originally to be viewed as the geometric correction vector.

On the basis of the geometric correction vector obtained in this manner, the display units 31 perform projection while changing arrangement of pixel positions of an original image to be displayed, whereby each pixel is projected at an appropriate pixel position due to optical distortion, and geometric correction can be implemented.

The blurring amount calculation unit 92 corrects an image captured by each of the cameras 51-1 to 51-m with a geometric correction vector, obtains a point spread function (hereinafter, also simply referred to as a PSF) serving as an index of a blurring amount of each pixel, and outputs the PSF to the correction parameter storage unit 15.

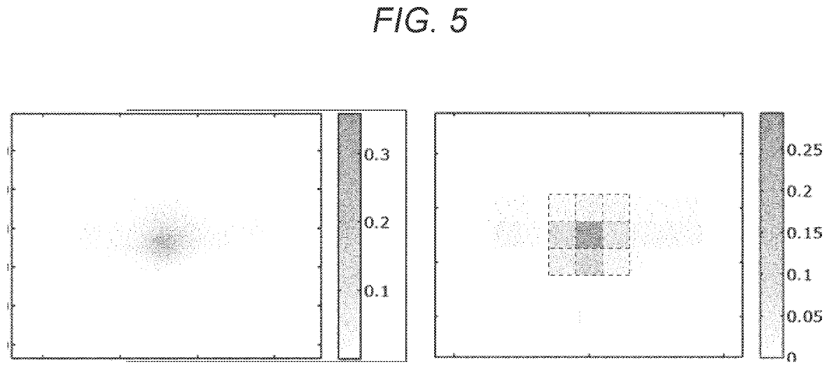

More specifically, an image including point light sources in one pixel unit as indicated by the image TP11 of FIG. 4 is used to perform image capturing with, for example, as illustrated in FIG. 5, a setting such that a plurality of pixels (at least about three pixels or more) can be resolved on a side of the cameras 51 with respect to one pixel on a side of the display units 31.

Since one pixel interval in the pattern of the image TP11 of FIG. 4 is known, by calculating the number of pixels corresponding to captured pixels from a pixel interval in an image obtained by capturing one pixel on the side of the display units 31, the blurring amount calculation unit 92 matches a captured image to a scale equivalent to that of the display units 31, and obtains a scaled value as spread for one pixel of the display units 31, that is, the PSF.

For example, in a case where spread of a pattern for one pixel in a captured image is captured as illustrated in a left part of FIG. 5, the blurring amount calculation unit 92 scales a size for one pixel of the display units 31 on the basis of an interval between pixels to obtain, as the PSF, spread of a pattern for one pixel as illustrated in a right part of FIG. 5.

In the right part of FIG. 5, the PSF for three pixels×three pixels scaled to a size corresponding to one pixel of the display units 31 is illustrated. A rectangular frame in the right part of FIG. 5 indicates the scaled size of one pixel.

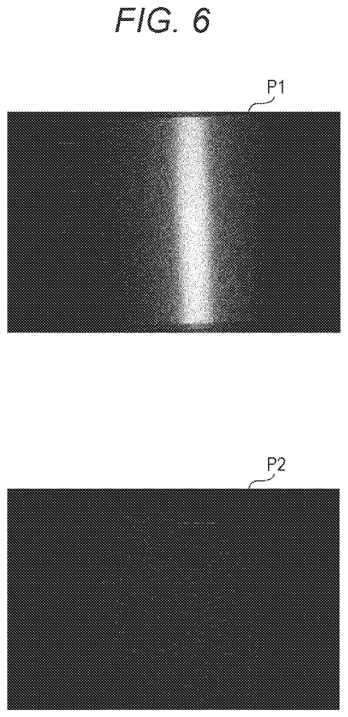

The diffusion distribution calculation unit 93 calculates a diffusion distribution for respective viewing directions of the cameras 51 by using an image (hereinafter, also referred to as all-white image) P1 obtained by capturing projection of an image in an all-pixel display state, and an image (hereinafter, also referred to as all-black image) P2 obtained by capturing projection of an image in an all-pixel non-display state, which are illustrated in FIG. 6.

More specifically, the diffusion distribution calculation unit 93 calculates, as a diffusion distribution of light, a result of subtracting a pixel value of each pixel of the all-black image from a pixel value of each pixel of the all-white image, in order to subtract an influence of ambient light such as illumination light of a room.

Since the subtraction result itself is a diffusion distribution in camera coordinates, the subtraction result is converted into a diffusion distribution in coordinates of the display units 31 by using correspondence information of the coordinates of the display units 31 and the cameras 51.

In the case of a 3D display using a projector array in which a plurality of the display units 31 including projectors is arranged, a diffusion distribution is acquired for each combination of the camera 51 installed at a predetermined position as a viewpoint and the display unit 31 including the projector.

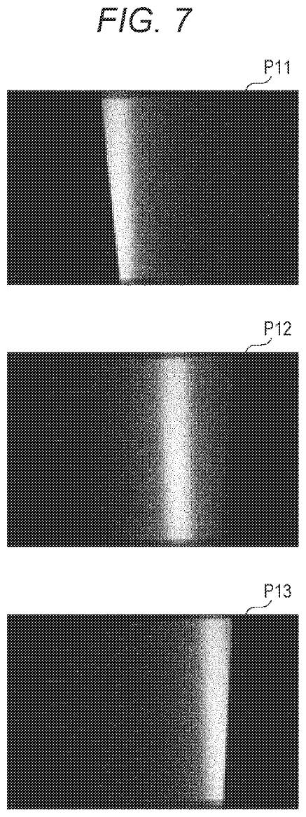

That is, the all-white image displayed by the same display unit 31 (the all-white image corresponding to the image P1 of FIG. 6) is captured as different images for respective viewpoint positions where the cameras 51 are provided, for example, as images P11 to P13 of FIG. 7, and is obtained as a diffusion distribution for each combination of the camera 51 and the display unit 31. In the images P11 to P13 of FIG. 7, distributions (diffusion distributions) diffused in the horizontal direction at different positions on a right side of a central position, the central position, and a left side of the central position in the horizontal direction of the images are illustrated from the top of the drawing.

The geometric correction vector, the blurring amount (PSF), and the diffusion distribution, which are the correction parameters obtained as described above, are stored in a geometric correction vector storage unit 111, a blurring amount storage unit 113, and a diffusion distribution storage unit 112 of the correction parameter storage unit 15, respectively.

### <Detailed Configuration Example of Correction Unit>

Next, a detailed configuration of the correction unit 74 of the image display unit 11 will be described with reference to FIG. 8.

The correction unit 74 includes a correction control unit 131, a geometric correction unit 132, a crosstalk correction unit 133, and a blurring correction unit 134.

The correction control unit 131 is controlled by the display control unit 71, and controls an entire operation of the correction unit 74. When multi-viewpoint images constituting a content stored in the content storage unit 73 are read by the display control unit 71, the correction control unit 131 reads a correction parameter stored in the correction parameter storage unit 15, applies correction on each image of the multi-viewpoint images constituting the content, and outputs the image to the display control unit 71. The display control unit 71 outputs the images of the content, which are corrected by the correction unit 74, to the display units 31-1 to 31-n and causes the display units 31-1 to 31-n to display the images.

More specifically, the geometric correction unit 132 reads a geometric correction vector from the geometric correction vector storage unit 111 of the correction parameter storage unit 15, and performs geometric correction on each pixel in multi-viewpoint images constituting a content.

The crosstalk correction unit 133 reads a diffusion distribution from the diffusion distribution storage unit 112 of the correction parameter storage unit 15, and performs crosstalk correction on the basis of the read diffusion distribution.

The blurring correction unit 134 reads a point spread function (PSF) corresponding to a correction parameter of a blurring amount from the blurring amount storage unit 113 of the correction parameter storage unit 15, and performs blurring correction by using the read PSF.

### <Crosstalk Correction>

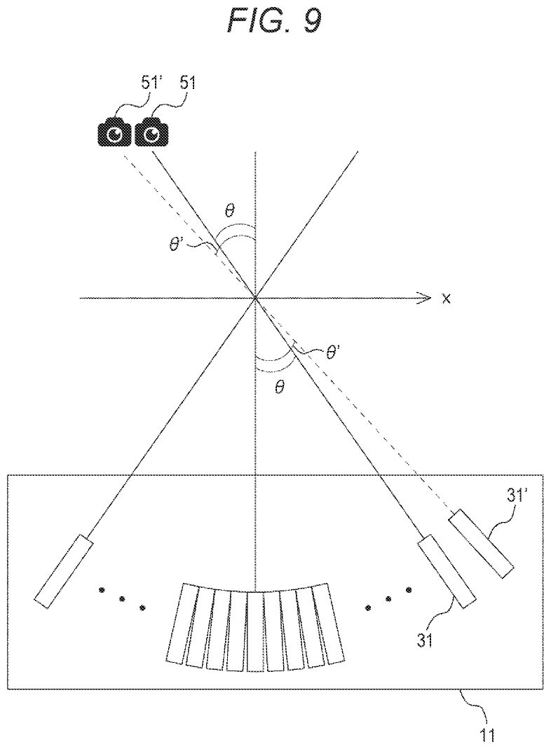

Here, the crosstalk correction will be described. For example, as illustrated in FIG. 9, in the case of a configuration in which the display units 31 of the image display unit 11 are arranged in the horizontal direction in the drawing, an image of a pixel column projected at an angle θ formed with respect to the directional screen 12 is captured (viewed) by the camera 51 installed at a corresponding position forming the angle θ with respect to the directional screen 12 by an optical path as indicated by a solid line.

When crosstalk does not occur, only the image on the facing display unit 31 is viewed in the camera 51. In addition, at this time, for example, in a case where a display unit 31′ is provided by changing a direction in one pixel column unit and an image is displayed, only the image on the display unit 31′ is viewed in a camera 51′ installed at a position shifted by one pixel column and forming an angle θ′ with respect to the directional screen 12.

In reality, since there is a viewing direction in which no image is displayed between the display unit 31 and the display unit 31′, in a case where the images projected by the display units 31 and 31′ are viewed as they are, the images are viewed as images including only discrete pixel columns in the horizontal direction.

In order to prevent the images from being viewed as discrete pixel columns in this manner, the directional screen 12 is provided.

The directional screen 12 diffuses an image of each pixel column projected by each of the display units 31 in the horizontal direction within a range of a predetermined angle, so that the pixel columns discretely projected in the horizontal direction can be viewed as the images continuously arranged in the horizontal direction.

However, the image of each pixel column projected by each of the display units 31 is diffused and projected by the directional screen 12, so that a part of images of adjacent pixel columns is viewed in an overlapping manner.

That is, in FIG. 9, in the case of the camera 51′ installed at the position slightly shifted from the installation position (viewing position) of the camera 51 and forming, with respect to the directional screen 12, for example, the angle θ′ with respect to θ, the image of the pixel column projected by the display unit 31 is diffused in the horizontal direction with respect to a projection direction by the directional screen 12, and the image of the corresponding pixel column on the display unit 31′ installed at the position adjacent to the display unit 31 is diffused, so that the image of the pixel column projected by the display unit 31 is captured (viewed) as an image in which both images are mixed.

In this manner, crosstalk is a phenomenon in which images of a plurality of pixel columns projected adjacent to each other are diffused under an influence of the directional screen 12, and thus, are mixed and viewed at the same image capturing position (viewing position).

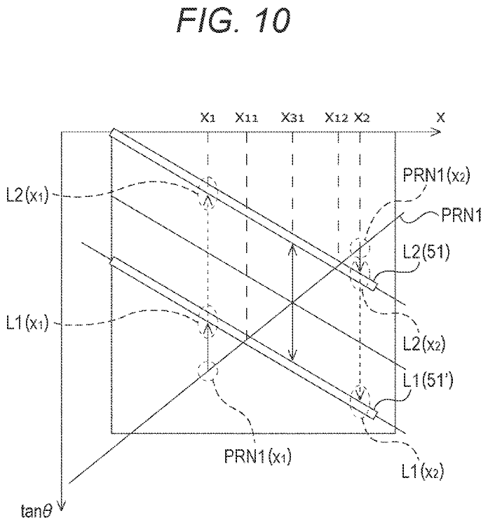

When a positional relationship between the display unit 31 and the camera 51 illustrated in FIG. 9 is expressed by taking a coordinate x in the horizontal direction with respect to the directional screen 12 as a horizontal axis and tan θ corresponding to the angle θ formed by the viewing position with respect to the directional screen 12 as a vertical axis, in a case where there is no influence of diffusion, pixel columns viewed in the respective positional relationships are arranged on straight lines L1 and L2 on an x−tan θ plane of FIG. 10.

More specifically, in a case where the installation positions (viewing positions) of the cameras 51 are the installation positions of the cameras 51 and 51′ of FIG. 9, pixel columns to be viewed are arranged on the straight lines L1 and L2 according to the positional relationship between the coordinate x in the horizontal direction and the angle θ formed by the viewing position with respect to the directional screen 12.

That is, in FIG. 9, in a case where each of the cameras 51 and 51′ captures (views) an image projected on the directional screen 12, when a position of a pixel column to be viewed increases with respect to the coordinate x in the horizontal direction, the angle θ with respect to the directional screen 12 also increases. Thus, in both of the cameras 51 and 51′, pixel columns viewed on the directional screen 12 are arranged on straight lines indicated by the right-downward straight lines L1 and L2 as illustrated in FIG. 10.

Furthermore, in FIG. 9, the installation position of the camera 51 has an x coordinate position in the horizontal direction with respect to the directional screen 12 larger than that of the installation position of the camera 51′, and the camera 51 is installed to be shifted rightward in the drawing. Thus, in a case where a pixel column at the same position in the horizontal direction is viewed on the directional screen 12, the angle θ′ of the camera 51′ with respect to the directional screen 12 is larger than the angle θ of the camera 51 with respect to the directional screen.

Therefore, in a case where a relationship between a position in the horizontal direction of a pixel column in which the camera 51 is to be viewed and tan θ when an angle with respect to the directional screen 12 is θ is expressed by the straight line L2, a pixel column in which the camera 51′ is to be viewed is arranged on the straight line L1 of FIG. 10 in which an intercept of tan θ is large in the drawing.

On the other hand, for pixel columns projected on the directional screen 12 by the same display unit 31, the angle θ, that is, tan θ decreases as the coordinate x, which is the position of the pixel column on the directional screen 12, increases.

Therefore, pixel columns to be projected on the directional screen 12 by the same display unit 31 are arranged on a straight line as indicated by a straight line PRN1, for example. Note that, although not illustrated, pixel columns to be projected on the directional screen 12 by different display units 31 are arranged on lines in a direction similar to a direction of the straight line PRN1 according to positions of the display units 31 in the horizontal direction.

That is, in an image projected from one display unit 31, pixel columns viewed from different viewing directions with respect to the horizontal direction are arranged according to positions in the horizontal direction.

When an image displayed by the display unit 31 is in a state of being captured by each of the cameras 51 (a state of being viewable from each viewing position) without the directional screen 12 and without diffusion, crosstalk does not occur as described above. However, in reality, since there is the directional screen 12, crosstalk occurs due to occurrence of diffusion.

That is, a diffusion distribution of each of the display units 31 is calculated by the diffusion distribution calculation unit 93 as described above, and is stored as a correction parameter in the diffusion distribution storage unit 112 of the correction parameter storage unit 15.

Thus, the crosstalk correction unit 133 corrects crosstalk by causing an image in a dominant viewing direction to be selectively displayed for each pixel column of each display unit 31 on the basis of the diffusion distribution stored in the diffusion distribution storage unit 112.

More specifically, for example, when images of pixel columns projected by a specific display unit 31 are arranged on a straight line indicated by the straight line PRN1, images of pixel columns projected by a display unit 31 corresponding to coordinate positions in the horizontal direction of FIG. 10 have different magnitude of reflection due to an influence of diffusion according to the viewing positions of the cameras 51 and 51′.

That is, in the case of a coordinate x1 with respect to the horizontal direction of FIG. 10, a pixel column PRN1(x1) of an image displayed by the display unit 31 is reflected in a pixel column L1(x1) on the straight line L1 captured by the camera 51′ and viewed, and, in the camera 51, the pixel column PRN1(x1) is reflected in a pixel column L2(x1) on the straight line L2 and viewed, by diffusion.

When the pixel columns L1(x1) and L2(x1) are compared with each other, the pixel column L1(x1) is closer to the straight line PRN1 on which the images projected by the display unit 31 are arranged than the pixel column L2(x1), so that an influence of diffusion is large and reflection easily occurs.

In contrast, the pixel column L2(x1) is farther from the straight line PRN1 on which the images projected by the display unit 31 are arranged than the pixel column L1(x1), so that an influence of diffusion is small and reflection less easily occurs.

On the other hand, in the case of a coordinate x2 with respect to the horizontal direction of FIG. 10, a pixel column PRN1(x2) of an image displayed by the display unit 31 is reflected in a pixel column L1(x2) on the straight line L1 captured by the camera 51′ and viewed, and, in the camera 51, the pixel column PRN1(x2) is reflected in a pixel column L2(x2) on the straight line L2 and viewed, by diffusion.

When the pixel columns L1(x2) and L2(x2) are compared with each other, the pixel column L1(x2) is farther from the straight line PRN1 on which the images projected by the display unit 31 are arranged than the pixel column L2(x2), so that an influence of diffusion is small and reflection less easily occurs.

In contrast, the pixel column L2(x2) is closer to the straight line PRN1 on which the images projected by the display unit 31 are arranged than the pixel column L1(x2), so that the influence of diffusion is large and reflection easily occurs.

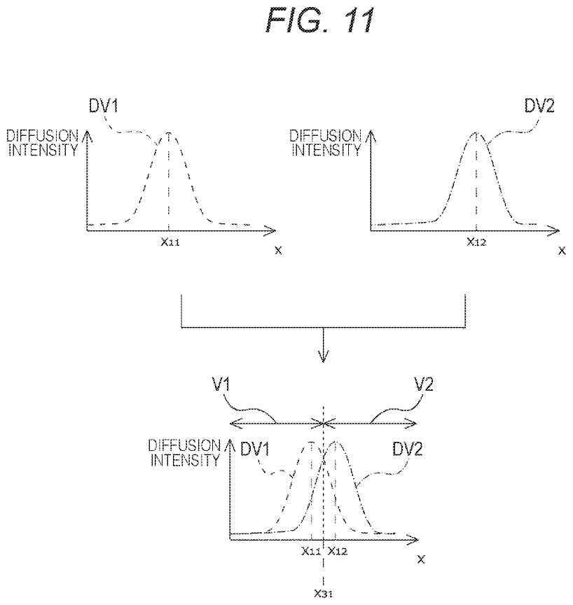

When expressed by a diffusion distribution, a relationship as illustrated in FIG. 11 is obtained.

That is, a diffusion distribution in the camera 51 is a diffusion distribution DV2 indicated by an alternate long and short dash line in an upper right part of FIG. 11 with a coordinate x12 in the horizontal direction of FIG. 10 as a peak, and a diffusion distribution in the camera 51′ is a diffusion distribution DV1 indicated by a dotted line in an upper left part of FIG. 11 with a coordinate x11 in the horizontal direction of FIG. 10 as a peak. Note that, in FIG. 11, a vertical axis represents diffusion intensity, and a horizontal axis represents the coordinate x in the horizontal direction of the directional screen 12.

The diffusion intensity mentioned herein is an index indicating easiness of reflection of a pixel column with respect to the coordinate x in the horizontal direction of an image diffused by the directional screen 12, and stronger diffusion intensity indicates a state in which the pixel column is more easily reflected and viewed, and weaker diffusion intensity indicates a state in which the pixel column is less easily reflected and viewed.

Therefore, the diffusion distribution DV1 indicates that, in the camera 51′, with respect to the images projected by the display units 31, an image of a pixel column in the vicinity of the coordinate x11 is easily viewed, and it is difficult to view an image of a pixel column as a distance from the coordinate x11 increases.

In addition, the diffusion distribution DV2 indicates that, in the camera 51, with respect to the images projected by the display units 31, an image of a pixel column in the vicinity of the coordinate x12 is easily viewed, and it is difficult to view an image of a pixel column as a distance from the coordinate x12 increases.

When the diffusion distributions DV1 and DV2 in the upper right part and the upper left part of FIG. 11 are overlapped, a relationship as illustrated in a lower center part of FIG. 11 is obtained. That is, according to waveforms in the lower center part of FIG. 11, an influence of diffusion in the camera 51 becomes dominant on a right side of a coordinate x31 of FIG. 10 where the waveforms in the drawing intersect, and an influence of diffusion in the camera 51′ becomes dominant on a left side of the coordinate x31. That is, in the display unit 31 in which pixel columns to be displayed are arranged on a straight line expressed by the straight line PRN1, the coordinate x31 in the horizontal direction is a boundary indicating an influence of diffusion in the cameras 51 and 51′.

Therefore, for the images that are projected by the display unit 31 and represented by a straight line PRL1, the crosstalk correction unit 133 sets the pixels on the right side of the coordinate x31 in the horizontal direction as an image V1 of the camera 51 and an image V2 of the camera 51′.

By specifying a pixel column of an image to be displayed to an image of each viewpoint position in this manner, for each pixel, a pixel of a viewpoint image affected by diffusion is selectively used for each pixel column. Thus, an influence of crosstalk can be suppressed.

Hereinafter, a distribution obtained by overlapping diffusion distributions of the plurality of cameras 51 as illustrated in the lower center part of FIG. 11 is also referred to as a determination distribution.

Therefore, in performing the crosstalk correction, the crosstalk correction unit 133 obtains a determination distribution by using a diffusion distribution of each of the plurality of cameras 51, determines a boundary in the horizontal direction on the basis of the determination distribution, and determines an image of a viewpoint to be displayed in each pixel column on the display unit 31 on the basis of the determined boundary.

By this series of processing, the crosstalk correction unit 133 performs the crosstalk correction.

Note that, in the above example, an example has been described in which the determination distribution is obtained by using the diffusion distribution of each of the two cameras 51. However, the determination distribution may be obtained from the diffusion distributions of more cameras 51, and a plurality of boundaries may be obtained.

In addition, in the above, an example has been described in which a pixel column for each viewing position of the camera 51 is assigned for each range in the horizontal direction set by the obtained boundary. However, in a case where the boundary is obtained, an image may be assigned to each pixel column at a coordinate position in the horizontal direction by another method. For example, a weight may be set according to a distance from the boundary, and mixing (blending) may be performed by using a weighted average.

### <Outline of Correction Using Plurality of Correction Parameters>

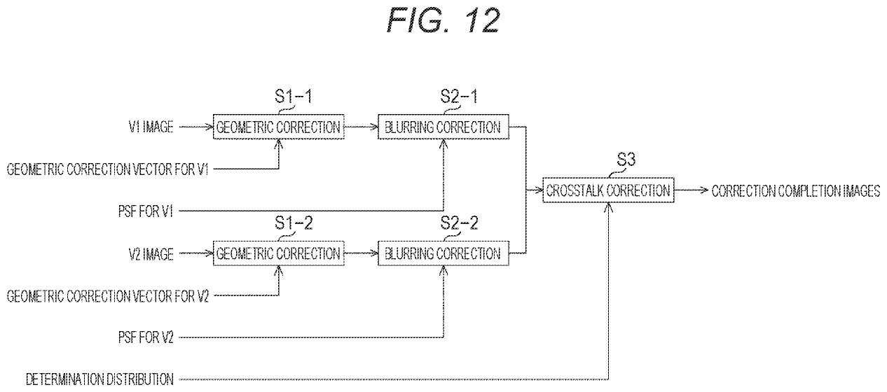

An outline of correction using a plurality of correction parameters is as illustrated in FIG. 12. Note that, here, an example of using the images V1 and V2 in two viewpoint directions will be described, but images in more viewpoint directions may be used.

That is, in processing S1-1, the correction control unit 131 controls the geometric correction unit 132 to geometrically correct the image V1 by using a geometric correction vector for the image V1 from the geometric correction vector storage unit 111.

In addition, in processing S1-2, the correction control unit 131 controls the geometric correction unit 132 to geometrically correct the image V2 by using a geometric correction vector for the image V2 from the geometric correction vector storage unit 111.

In processing S2-1, the correction control unit 131 controls the blurring correction unit 134 to correct blurring of the geometrically corrected image V1 by using a PSF that is a blurring amount for the image V1 and is stored in the blurring amount storage unit 113.

In processing S2-2, the correction control unit 131 controls the blurring correction unit 134 to correct blurring of the geometrically corrected image V2 by using a PSF that is a blurring amount for the image V2 and is stored in the blurring amount storage unit 113.

In processing S3, the correction control unit 131 controls the crosstalk correction unit 133 to obtain a determination distribution by using a diffusion distribution of each of the images V1 and V2, which is stored in the diffusion distribution storage unit 112, and on the basis of the determination distribution, applies crosstalk correction by using the images V1 and V2 subjected to the geometric correction and the blurring correction, and outputs resultant images as correction completion images.

That is, by the series of processing described above, the blurring correction is performed on each of the images at the respective viewpoints after geometric distortion is corrected. Thus, it is possible to perform the blurring correction using the PSF corresponding to a final display position in a screen. That is, by performing the crosstalk correction after performing the appropriate blurring correction, appropriate correction using a plurality of correction parameters can be implemented.

### <Correction Parameter Calculation Processing>

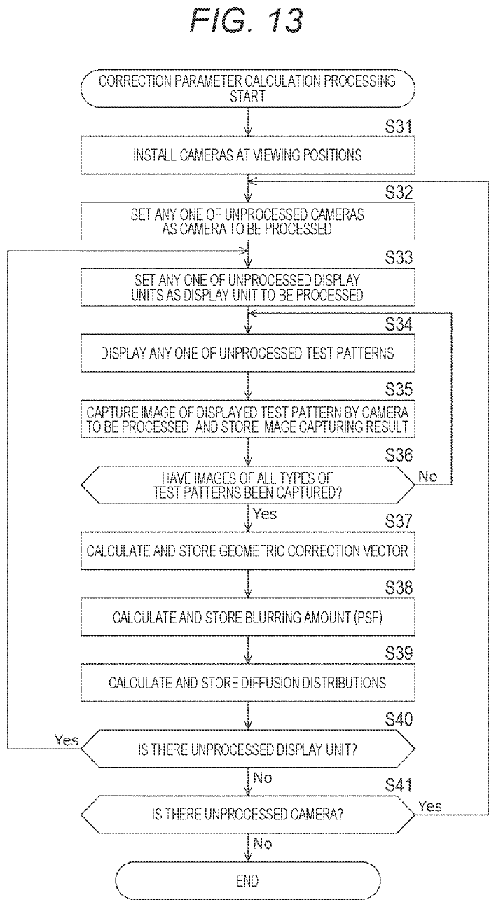

Next, correction parameter calculation processing will be described with reference to a flowchart of FIG. 13.

In Step S31, the cameras 51-1 to 51-m are installed at respective viewing positions. With such processing, the test pattern image capturing unit 13 is configured.

In Step S32, the test pattern image capturing unit 13 sets any one of the cameras at an unprocessed viewpoint as a camera to be processed.

In Step S33, the display control unit 71 sets any one of the display units 31-1 to 31-n as a display unit to be processed.

In Step S34, the display control unit 71 causes the display unit to be processed to display any one of unprocessed test patterns among test patterns stored in the test pattern storage unit 72.

In Step S35, the test pattern image capturing unit 13 controls the camera to be processed to capture an image of the test pattern displayed by the display unit to be processed, and causes the correction parameter calculation unit 14 to output an image capturing result. Here, the correction parameter calculation unit 14 stores the image obtained by capturing the test pattern, which is supplied from the test pattern image capturing unit 13, in association with the camera 51.

In Step S36, the display control unit 71 determines whether or not all the test patterns stored in the test pattern storage unit 72 are displayed.

In a case where it is determined in Step S36 that not all the test patterns are displayed, the processing returns to Step S34.

That is, the processing of Steps S34 to S36 is repeated until all the test patterns are displayed.

Then, in a case where it is determined in Step S36 that all the test patterns are displayed, the processing proceeds to Step S37.

In Step S37, the geometric correction vector calculation unit 91 calculates a geometric correction vector by comparing the image obtained by capturing the test pattern with a known test pattern, and causes the geometric correction vector storage unit 111 of the correction parameter storage unit 15 to store the geometric correction vector as a correction parameter.

At this time, the geometric correction vector calculation unit 91 stores the obtained geometric correction vector and the camera 51 in association with each other.

In addition, the geometric correction vector calculation unit 91 outputs the calculated geometric correction vector to each of the blurring amount calculation unit 92 and the diffusion distribution calculation unit 93.

In Step S38, the blurring amount calculation unit 92 applies geometric correction on an image obtained by capturing a test pattern including point light sources on the basis of the geometric correction vector, calculates a PSF as a blurring amount, and causes the blurring amount storage unit 113 of the correction parameter storage unit 15 to store the PSF as a correction parameter.

In Step S39, the diffusion distribution calculation unit 93 applies geometric correction on images in which test patterns including an all-white image and an all-black image are captured on the basis of the geometric correction vector, calculates diffusion distributions, and causes the diffusion distribution storage unit 112 to store the diffusion distributions as correction parameters.

In Step S40, the display control unit 71 determines whether or not there is an unprocessed display unit 31, and in a case where there is an unprocessed display unit 31, the processing returns to Step S33.

That is, the processing of Steps S33 to S40 is repeated until all types of test patterns are displayed on all the display units 31, and all correction parameters are calculated. Then, in a case where it is determined in Step S40 that all types of test patterns are displayed on all the display units 31, all correction parameters are calculated, and there is no unprocessed display unit 31, the processing proceeds to Step S41.

In Step S41, the test pattern image capturing unit 13 determines whether or not there is a camera 51 at an unprocessed viewpoint, and in a case where there is a camera 51 at an unprocessed viewpoint, the processing returns to Step S32.

That is, the processing of Steps S32 to S41 is repeated until images of all types of test patterns are captured by the cameras 51 at all viewpoints for all the display units 31, and all correction parameters are calculated.

Then, in a case where it is determined in Step 41 that image capturing has been performed by the cameras 51 at all viewpoints, the processing ends.

By the processing described above, images when all the test patterns are displayed on all the display units 31 are captured by the cameras 51 at all the viewpoints, and all the correction parameters are obtained and stored in the correction parameter storage unit 15.

### <Display Processing>

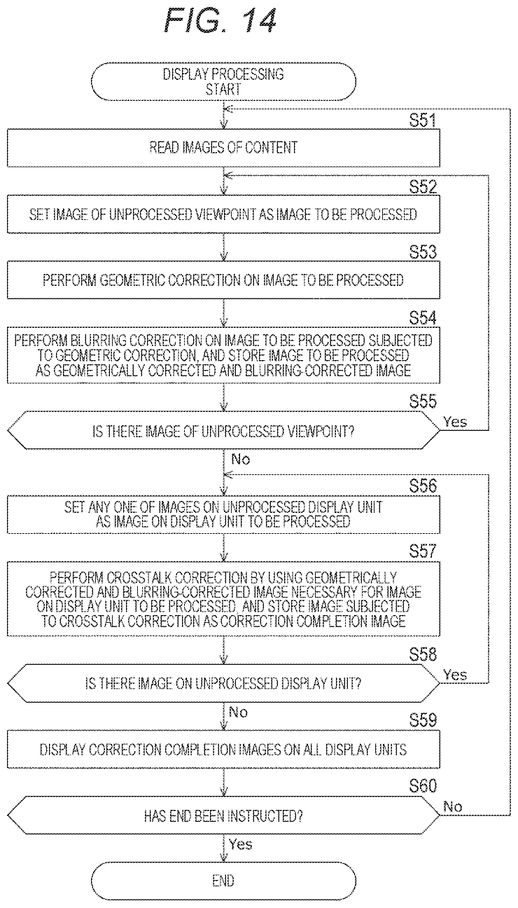

Next, display processing will be described with reference to a flowchart of FIG. 14.

In Step S51, the display control unit 71 reads image data constituting multi-viewpoint images of a content stored in the content storage unit 73.

In Step S52, the display control unit 71 sets an image of an unprocessed viewpoint among the read multi-viewpoint images as an image to be processed.

In Step S53, the display control unit 71 supplies the image to be processed to the correction unit 74 to cause the correction unit 74 to perform geometric correction.

More specifically, the correction control unit 131 of the correction unit 74 supplies the image to be processed to the geometric correction unit 132 to cause the geometric correction unit 132 to perform geometric correction.

The geometric correction unit 132 reads a geometric correction vector from the geometric correction vector storage unit 111 of the correction parameter storage unit 15, performs geometric correction on the image to be processed on the basis of the read geometric correction vector, and returns the image to be processed to the correction control unit 131.

In Step S54, the correction control unit 131 outputs the image to be processed subjected to the geometric correction to the blurring correction unit 134 to cause the blurring correction unit 134 to perform blurring correction.

More specifically, the blurring correction unit 134 reads a PSF that is a blurring amount from the blurring amount storage unit 113 of the correction parameter storage unit 15, performs blurring correction on the image to be processed subjected to the geometric correction, and returns the image to be processed subjected to the geometric correction and the blurring correction to the correction control unit 131 as a geometrically corrected and blurring-corrected image.

In Step S55, the correction control unit 131 determines whether or not there is an image to be displayed on the display unit 31 at an unprocessed viewpoint, and in a case where there is an image of an unprocessed viewpoint, the processing returns to Step S52.

That is, the processing of Steps S52 to S55 is repeated until the geometric correction and the blurring correction are performed on images of all viewpoints.

Then, in a case where it is determined in Step S55 that there is no image of an unprocessed viewpoint, the processing proceeds to Step S56.

In Step S56, the correction control unit 131 sets an unprocessed display unit 31 as a display unit to be processed.

In Step S57, the correction control unit 131 controls the crosstalk correction unit 133 to apply crosstalk correction on an image displayed on the display unit 31 set as the display unit to be processed by using a geometrically corrected and blurring-corrected image of a necessary viewpoint, and stores the image subjected to the crosstalk correction as a correction completion image.

More specifically, the crosstalk correction unit 133 reads, from the diffusion distribution storage unit 112 of the correction parameter storage unit 15, a diffusion distribution obtained from an image captured by the camera 51 at a viewpoint necessary to set each pixel column of the display unit 31 set as the display unit to be processed, and applies crosstalk correction as described with reference to FIGS. 9 and 10, and returns the diffusion distribution to the correction control unit 131.

In Step S58, the correction control unit 131 determines whether or not there is an unprocessed display unit 31, and in a case where there is an unprocessed display unit 31, the processing returns to Step S56.

That is, the processing of Steps S56 to S58 is repeated until each of pixel columns of images displayed by all the display units 31 is subjected to the crosstalk correction and becomes a correction completion image.

Then, in a case where it is determined in Step S58 that the correction completion images to be displayed on all the display units 31 have been generated, the processing proceeds to Step S59.

In Step S59, the correction control unit 131 uses the images in the respective viewpoint directions subjected to the geometric correction and the blurring correction to supply, to the display control unit 71, the image to be displayed on each of the display units 31, which is subjected to the crosstalk correction based on the diffusion distribution.

The display control unit 71 uses the images in the respective viewpoint directions subjected to the geometric correction and the blurring correction to output, to each of the display units 31, the correction completion image to be displayed on each of the display units 31, which is subjected to the crosstalk correction based on the diffusion distribution, and to cause each of the display units 31 to display the correction completion image.

In Step S60, the display control unit 71 determines whether or not an end of display has been instructed, and in a case where the end of display has not been instructed, the processing returns to Step S51, and processing of subsequent steps is repeated. That is, until the end is instructed, a multi-viewpoint image is sequentially read, subjected to the geometric correction, the blurring correction, and the crosstalk correction, and is continuously displayed on each of the display units 31-1 to 31-n.

Then, in a case where it is determined in Step S60 that the end of the processing has been instructed, the processing ends.

By the processing described above, in consideration of characteristics of the directional screen 12 such as the diffuser, the lenticular, and the parallax barrier, a viewpoint and an output pixel can be corresponded to each other, and the geometric correction, the blurring correction, and the crosstalk correction can be appropriately performed. Thus, it is possible to achieve display of a multi-viewpoint image in which a geometric failure, crosstalk (image mixture between viewpoints), and blurring (image deterioration within a viewpoint) are suppressed.

As the multi-viewpoint image, not only a three-dimensional image but also a two-dimensional image or the like having directivity can be applied.

Furthermore, as the configuration of the display unit 31, not only a projector used in combination with a diffuser, but also a display device such as a liquid crystal display (LCD) and an organic light emitting diode (OLED) using a directional device such as a lenticular lens and a parallax barrier can be applied. In addition, the shape of the display unit 31 is also not particularly limited, and not only a planar configuration, but also a curved configuration can be applied, for example.

### 2. Application Example

### <Outline of Another Example of Correction Using Plurality of Correction Parameters>

In the above, an example has been described in which, to images of the respective viewpoints, geometric correction is applied, and then blurring correction is applied, and the crosstalk correction is applied.

In this case, in a state where a pixel position of each pixel is geometrically corrected, blurring correction is performed by using a PSF that is a blurring amount obtained for each pixel position. Thus, it is possible to implement appropriate blurring correction.

However, in a case where it is difficult to implement the blurring correction in real time, the geometric correction may be applied after the blurring correction is performed first.

That is, in a case where it is difficult to perform blurring correction in real time, such as in a case where a geometric change such as distortion occurs over time depending on an application of the display unit 31 and it is necessary to perform geometric correction each time the geometric change occurs, or in a case where it is necessary to apply blurring correction on a moving image content or the like, the geometric correction may be applied after the blurring correction is applied.

More specifically, the images of the respective viewpoint positions are subjected to blurring correction off-line in advance and stored.

Then, when the images of the respective viewpoints are displayed on the display units 31, the images of the respective viewpoint positions subjected to the blurring correction are read, the geometric correction is performed, and then the crosstalk correction is applied to display the images.

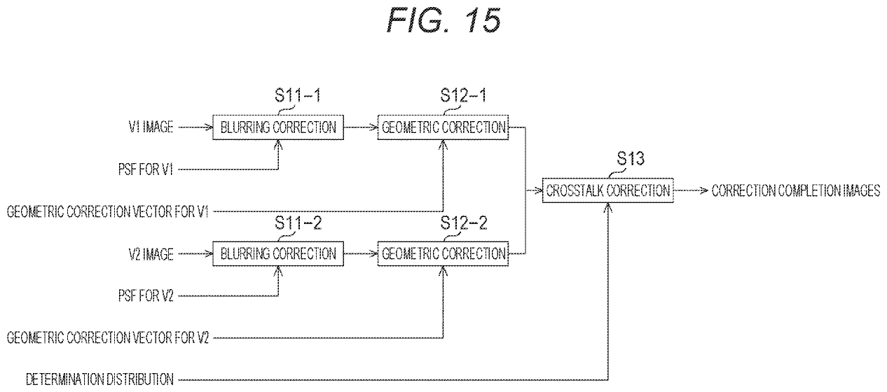

More specifically, as illustrated in FIG. 15, in processing S11-1, the correction control unit 131 controls the blurring correction unit 134 to correct blurring of the image V1 by using a PSF that is a blurring amount for the image V1 stored in the blurring amount storage unit 113.

In processing S11-2, the correction control unit 131 controls the blurring correction unit 134 to correct blurring of the image V2 by using a PSF that is a blurring amount for the image V2 stored in the blurring amount storage unit 113.

The processing of applying the blurring correction in the processing S11-1 and S11-2 is off-line processing executed in advance, and the images V1 and V2 subjected to the blurring correction, which are processing results, may be output to the display control unit 71 by the correction control unit 131 or the like and stored in the content storage unit 73.

Then, when the images of the respective viewpoints, which are images of a content, are displayed by the display units 31, in processing S12-1, the correction control unit 131 controls the geometric correction unit 132 to geometrically correct the image V1 subjected to the blurring correction by using a geometric correction vector for the image V1 from the geometric correction vector storage unit 111.

In addition, in processing S12-2, the correction control unit 131 controls the geometric correction unit 132 to geometrically correct the image V2 subjected to the blurring correction by using a geometric correction vector for the image V2 from the geometric correction vector storage unit 111.

In processing S13, the correction control unit 131 controls the crosstalk correction unit 133 to obtain a determination distribution by using a diffusion distribution of each of the images V1 and V2, which is stored in the diffusion distribution storage unit 112, and on the basis of the determination distribution, applies crosstalk correction by using the images V1 and V2 subjected to the geometric correction after subjected to the blurring correction, and outputs resultant images as correction completion images.

That is, by the series of processing described above, by applying blurring correction, geometric correction, and crosstalk correction on multi-viewpoint images and projecting the multi-viewpoint images from the display units 31, it is possible to achieve display of the multi-viewpoint images in which a geometric failure, crosstalk (image mixture between viewpoints), and blurring (image deterioration within a viewpoint) are suppressed.

This application example is particularly effective in a case where a change in a PSF is small or a case where a degree of geometric correction (magnitude of a geometric correction vector) is small in a screen of each viewpoint, and in such a case, an influence on blurring correction is small. Thus, it is possible to achieve effective blurring correction in real time.

### <Off-Line Blurring Correction Processing>

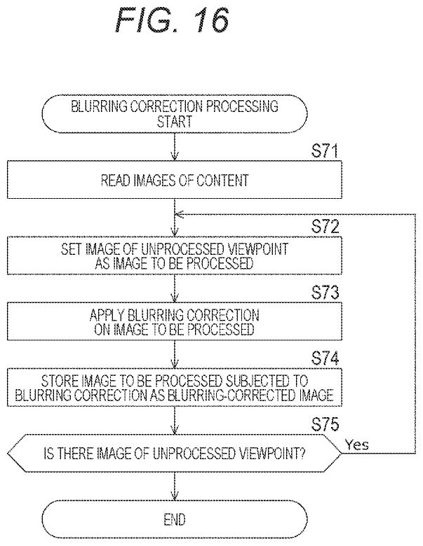

Next, off-line blurring correction processing will be described with reference to a flowchart of FIG. 16.

In Step S71, the display control unit 71 reads image data constituting multi-viewpoint images of a content stored in the content storage unit 73.

In Step S72, the display control unit 71 sets, as an image to be processed, an image of an unprocessed viewpoint, that is, a blurring-corrected image of an unprocessed viewpoint, among the read multi-viewpoint images.

In Step S73, the display control unit 71 supplies the image to be processed to the correction unit 74 to cause the correction unit 74 to perform blurring correction.

More specifically, the correction control unit 131 of the correction unit 74 supplies the image to be processed to the blurring correction unit 134. The blurring correction unit 134 reads a PSF that is a blurring amount from the blurring amount storage unit 113 of the correction parameter storage unit 15, performs blurring correction on the supplied image to be processed, and returns the image to be processed subjected to the blurring correction to the correction control unit 131.

The correction control unit 131 supplies the image to be processed subjected to the blurring correction to the display control unit 71.

In Step S74, the display control unit 71 causes the content storage unit 73 to store the image to be processed subjected to the blurring correction.

In Step S75, the display control unit 71 determines whether or not there is an image to be displayed on the display unit 31 at an unprocessed viewpoint, and in a case where there is an image of an unprocessed viewpoint, the processing returns to Step S72.

That is, the processing of Steps S72 to S75 is repeated until images of all viewpoints are subjected to the blurring correction and stored in the content storage unit 73.

Then, in a case where it is determined in Step S75 that there is no image of an unprocessed viewpoint, the processing ends.

By the processing described above, images of respective viewpoints subjected to blurring correction in advance by off-line processing are stored in the content storage unit 73. That is, at this point of time, each viewpoint image of a content including multi-viewpoint images is stored in the content storage unit 73 in a state where the blurring correction is performed.

### <Display Processing in Another Example of Correction Using Plurality of Correction Parameters>

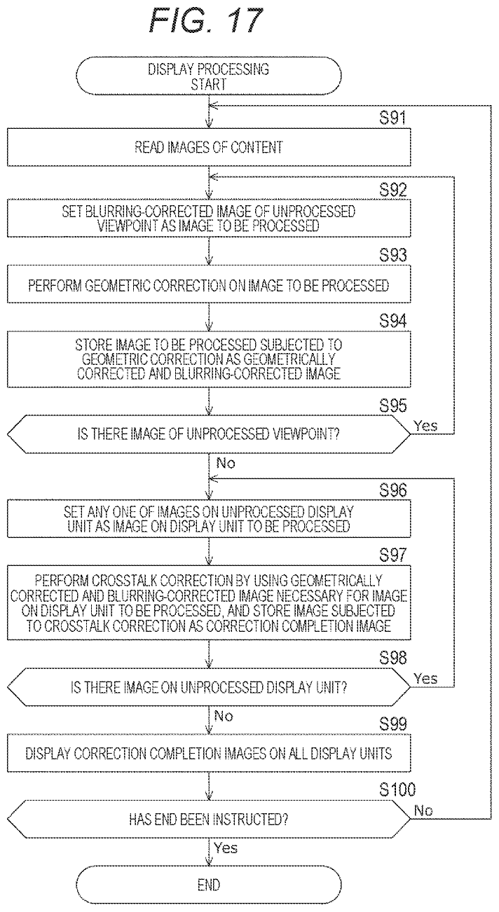

Next, display processing in another example of the correction using a plurality of correction parameters will be described with reference to a flowchart of FIG. 17.

In Step S91, the display control unit 71 reads image data constituting multi-viewpoint images of a content in a state where blurring correction is performed on images of the respective viewpoints, which is stored in the content storage unit 73.

In Step S92, the display control unit 71 sets, as an image to be processed, an image of an unprocessed viewpoint, that is, an image to be an unprocessed viewpoint, among the read multi-viewpoint images.

In Step S93, the display control unit 71 supplies the image to be processed to the correction unit 74 to cause the correction unit 74 to perform geometric correction.

More specifically, the correction control unit 131 of the correction unit 74 supplies the image to be processed to the geometric correction unit 132 to cause the geometric correction unit 132 to perform geometric correction.

The geometric correction unit 132 reads a geometric correction vector from the geometric correction vector storage unit 111 of the correction parameter storage unit 15, performs geometric correction on the blurring-corrected image that is the image to be processed on the basis of the read geometric correction vector, and returns the image to be processed to the correction control unit 131.

In Step S94, the correction control unit 131 stores the image obtained by performing the geometric correction on the image to be processed subjected to the blurring correction as a geometrically corrected and blurring-corrected image.

In Step S95, the correction control unit 131 determines whether or not there is an image of an unprocessed viewpoint, and in a case where there is an image of an unprocessed viewpoint, the processing returns to Step S92.

That is, the processing of Steps S92 to S95 is repeated until the blurring-corrected images of all viewpoints are subjected to the geometric correction and stored as the geometrically corrected and blurring-corrected images.

Then, in a case where it is determined in Step S95 that there is no image of an unprocessed viewpoint, the processing proceeds to Step S96.

In Step S96, the correction control unit 131 sets an unprocessed display unit 31 as a display unit to be processed.

In Step S97, the correction control unit 131 controls the crosstalk correction unit 133 to apply crosstalk correction on an image displayed on the display unit 31 set as the display unit to be processed by using an image of a necessary viewpoint, and stores the image as a correction completion image.

More specifically, the crosstalk correction unit 133 reads, from the diffusion distribution storage unit 112 of the correction parameter storage unit 15, a diffusion distribution an image of which is captured by the camera 51 at a viewpoint necessary to set each pixel column of the display unit 31 set as the display unit to be processed, and as described with reference to FIGS. 9 and 10, obtains a determination distribution, applies crosstalk correction on the basis of the determination distribution by using the geometrically corrected and blurring-corrected image, and returns a resultant image to the correction control unit 131 as a correction completion image.

In Step S98, the correction control unit 131 determines whether or not there is an unprocessed display unit 31, and in a case where there is an unprocessed display unit 31, the processing returns to Step S96.

That is, the processing of Steps S96 to S98 is repeated until each of pixel columns of images displayed by all the display units 31 is subjected to the crosstalk correction.

Then, in a case where it is determined in Step S98 that there is no unprocessed display unit 31 and the correction completion images to be displayed on all the display units 31 have been generated, the processing proceeds to Step S99.

In Step S99, the correction control unit 131 uses the images obtained by performing the geometric correction on the images in the respective viewpoint directions subjected to the blurring correction in advance to supply, to the display control unit 71, the correction completion image to be displayed on each of the display units 31, which is obtained by performing the crosstalk correction based on the diffusion distribution.

The display control unit 71 uses the images obtained by performing the geometric correction on the images in the respective viewpoint directions subjected to the blurring correction in advance to output, to each of the display units 31, the correction completion image to be displayed on each of the display units 31, which is obtained by performing the crosstalk correction based on the diffusion distribution, and causes each of the display units 31 to display the correction completion image.

In Step S100, the display control unit 71 determines whether or not an end of display has been instructed, and in a case where the end of display has not been instructed, the processing returns to Step S91, and processing of subsequent steps is repeated. That is, until the end is instructed, a content including multi-viewpoint images subjected to the blurring correction in advance is sequentially read, subjected to the geometric correction and the crosstalk correction, and is continuously displayed on each of the display units 31-1 to 31-n.

Then, in a case where it is determined in Step S100 that the end of the processing has been instructed, the processing ends.

Also in the processing described above, in consideration of characteristics of the directional screen 12 such as the diffuser, the lenticular, and the parallax barrier, a viewpoint and an output pixel can be corresponded to each other, and the geometric correction, the blurring correction, and the crosstalk correction can be appropriately performed. Thus, it is possible to achieve display of a multi-viewpoint image in which a geometric failure, crosstalk (image mixture between viewpoints), and blurring (image deterioration within a viewpoint) are suppressed.

Moreover, even in a case where it is difficult to perform blurring correction in real time, such as in a case where a geometric change such as distortion occurs over time depending on an application of the display unit 31 and it is necessary to perform geometric correction each time the geometric change occurs, or in a case where it is necessary to apply blurring correction on a moving image content or the like, by using an image subjected to the blurring correction in advance, it is possible to perform the geometric correction and the crosstalk correction in real time, and as a result, it is possible to implement correction in real time.

In addition, also in this example, as the multi-viewpoint image, not only a three-dimensional image but also a two-dimensional image or the like having directivity can be applied.

### 3. Example of Executing Processing by Software

Meanwhile, the series of processing described above can be executed by hardware, but can also be executed by software. In a case where the series of processing is executed by software, programs constituting the software are installed from a recording medium in a computer which is built in dedicated hardware, a general-purpose computer, for example, in which various programs can be installed for execution of various functions, or the like.

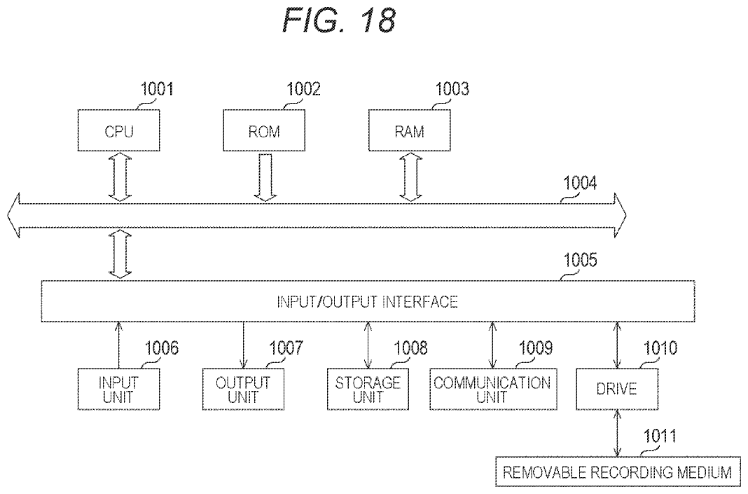

FIG. 18 illustrates a configuration example of a general-purpose computer. The personal computer incorporates a central processing unit (CPU) 1001. The CPU 1001 is connected with an input/output interface 1005 via a bus 1004. The bus 1004 is connected with a read only memory (ROM) 1002 and a random access memory (RAM) 1003.

The input/output interface 1005 is connected with an input unit 1006 including an input device such as a keyboard and a mouse used by a user for inputting operation commands, an output unit 1007 that outputs a processing operation screen or a processing result image to a display device, a storage unit 1008 including a hard disk drive that stores programs or various types of data, and a communication unit 1009 that includes a local area network (LAN) adaptor and executes communication processing via a network represented by the Internet. In addition, the input/output interface 1005 is connected with a drive 1010 that writes and reads data to and from a removable storage medium 1011 such as a magnetic disk (including a flexible disk), an optical disk (including a compact disc-read only memory (CD-ROM) and a digital versatile disc (DVD)), a magneto-optical disk (including a mini disc (MD)), or a semiconductor memory.

The CPU 1001 executes various types of processing according to programs stored in the ROM 1002, or programs read from the removable storage medium 1011 such as a magnetic disk, an optical disk, a magneto-optical disk, or a semiconductor memory, installed in the storage unit 1008, and loaded from the storage unit 1008 to the RAM 1003. The RAM 1003 also stores, as necessary, data or the like necessary for the CPU 1001 for executing various types of processing.

In the computer configured as described above, the series of processing described above is performed by, for example, the CPU 1001 loading programs stored in the storage unit 1008 into the RAM 1003 via the input/output interface 1005 and the bus 1004 to execute the programs.

The programs executed by the computer (CPU 1001) can be provided in a state of being recorded on the removable storage medium 1011 as a package medium or the like, for example. In addition, the programs can be provided via a wired or wireless transmission medium such as a local area network, the Internet, or digital satellite broadcasting.

In the computer, the programs can be installed in the storage unit 1008 via the input/output interface 1005 by mounting the removable storage medium 1011 on the drive 1010. In addition, the programs can be received by the communication unit 1009 via the wired or wireless transmission medium and installed in the storage unit 1008. Otherwise, the programs can be installed in advance in the ROM 1002 or the storage unit 1008.

Note that the programs executed by the computer may be programs by which processing is performed in time series in the order described in the present specification, or programs by which processing is performed in parallel or at a necessary timing such as on calling.

Note that the CPU 1001 in FIG. 18 implements the functions of the display control unit 71 and the correction unit 74 of FIG. 8.

In addition, in the present specification, a system means a set of a plurality of components (such as devices and modules (parts)), and it does not matter whether or not all the components are in the same housing. Thus, a plurality of devices housed in separate housings and connected via a network, and one device in which a plurality of modules is housed in one housing are both systems.

Note that embodiments of the present disclosure are not limited to the embodiment described above, and various modifications can be made without departing from the gist of the present disclosure.

For example, the present disclosure can have a configuration of cloud computing in which one function is shared and processed in cooperation by a plurality of devices via a network.

In addition, each step described in the flowcharts described above can be executed by one device, or can be shared and executed by a plurality of devices.

Moreover, in a case where a plurality of types of processing is included in one step, the plurality of types of processing included in the one step can be executed by one device, or can be shared and executed by a plurality of devices.

Note that the present disclosure can also have the following configurations.

<1> An image processing apparatus including:

a projection unit that projects multi-viewpoint images;

a geometric correction unit that performs geometric correction on the multi-viewpoint images; and

a crosstalk correction unit that performs crosstalk correction on the multi-viewpoint images.

<2> The image processing apparatus according to <1>, in which

the geometric correction unit performs geometric correction on the multi-viewpoint images on the basis of a geometric correction vector.

<3> The image processing apparatus according to <2>, in which

the geometric correction vector is obtained by comparing an image of a gray code test pattern projected by the projection unit with an image of a known gray code test pattern.

<4> The image processing apparatus according to <1>, in which

the crosstalk correction unit performs the crosstalk correction on the multi-viewpoint images on the basis of a diffusion distribution of each of the multi-viewpoint images.

<5> The image processing apparatus according to <4>, in which

the crosstalk correction unit performs, from a diffusion distribution in an adjacent viewpoint image in each of the multi-viewpoint images, the crosstalk correction by selectively using a pixel of the viewpoint image affected by diffusion for each position in a horizontal direction in each of the multi-viewpoint images.

<6> The image processing apparatus according to <5>, in which

the crosstalk correction unit generates, from the diffusion distribution in the adjacent viewpoint image in each of the multi-viewpoint images, a determination distribution for selectively using the pixel of the viewpoint image affected by the diffusion for each position in the horizontal direction in each of the multi-viewpoint images, and performs the crosstalk correction on the multi-viewpoint images on the basis of the determination distribution.

<7> The image processing apparatus according to <4>, in which

the diffusion distribution is obtained on the basis of an image that is a difference between a test pattern including an all-white image and a test pattern including an all-black image, the test patterns being projected by the projection unit.

<8> The image processing apparatus according to <1>, in which

the crosstalk correction unit performs the crosstalk correction on the multi-viewpoint images on the basis of a diffusion distribution of each of the multi-viewpoint images subjected to the geometric correction.

<9> The image processing apparatus according to <1>, further including

a blurring correction unit that performs blurring correction on the multi-viewpoint images.

<10> The image processing apparatus according to <9>, in which

the blurring correction unit performs blurring correction on the basis of a point spread function (PSF) in each pixel of the multi-viewpoint images.

<11> The image processing apparatus according to <10>, in which

the point spread function (PSF) is obtained from an image of a test pattern including one pixel pattern, the image being projected by the projection unit.

<12> The image processing apparatus according to <9>, in which

the blurring correction unit performs blurring correction on the multi-viewpoint images subjected to geometric correction by the geometric correction unit.

<13> The image processing apparatus according to <9>, in which

the crosstalk correction unit performs the crosstalk correction on the multi-viewpoint images subjected to geometric correction by the geometric correction unit, and further subjected to blurring correction by the blurring correction unit.

<14> The image processing apparatus according to <9>, in which

the geometric correction unit performs geometric correction on the multi-viewpoint images subjected to blurring correction by the blurring correction unit.

<15> The image processing apparatus according to <14>, in which

the crosstalk correction unit performs the crosstalk correction on the multi-viewpoint images subjected to blurring correction by the blurring correction unit, and further subjected to geometric correction by the geometric correction unit.

<16> The image processing apparatus according to any one of <1> to <15>, in which

the projection unit includes a projector array that projects the multi-viewpoint images, a liquid crystal display (LCD), and an organic light emitting diode (OLED).

<17> The image processing apparatus according to any one of <1> to <16>, further including

a directional screen that diffuses and projects the multi-viewpoint images projected by the projection unit as viewpoint images having directivity.

<18> The image processing apparatus according to <17>, in which

the directional screen includes a lenticular lens (microlens array), a parallax barrier, and a lens diffuser.

<19> An image processing method including:

projection processing of projecting multi-viewpoint images;

geometric correction processing of performing geometric correction on the multi-viewpoint images; and

crosstalk correction processing of performing crosstalk correction on the multi-viewpoint images.

<20> A program for causing a computer to function as:

a geometric correction unit that performs geometric correction on multi-viewpoint images projected by a projection unit; and

a crosstalk correction unit that performs crosstalk correction on the multi-viewpoint images.

### REFERENCE SIGNS LIST

1 Image processing system
11 Image display unit
12 Directional screen
13 Test pattern image capturing unit
14 Correction parameter calculation unit
15 Correction parameter storage unit
31, 31-1 to 31-n Display unit
51, 51-1 to 51-m Image capturing unit
71 Display control unit
72 Test pattern storage unit
73 Content storage unit
74 Correction unit
91 Geometric correction vector calculation unit
92 Blurring amount calculation unit
93 Diffusion distribution calculation unit
111 Geometric correction vector storage unit
112 Diffusion distribution storage unit
113 Blurring amount correction unit
131 Correction control unit
132 Geometric correction unit
133 Crosstalk correction unit
134 Blurring correction unit

1. An image processing apparatus comprising:
a projection unit that projects multi-viewpoint images;
a geometric correction unit that performs geometric correction on the multi-viewpoint images; and
a crosstalk correction unit that performs crosstalk correction on the multi-viewpoint images.

2. The image processing apparatus according to claim 1, wherein
the geometric correction unit performs geometric correction on the multi-viewpoint images on a basis of a geometric correction vector.

3. The image processing apparatus according to claim 2, wherein
the geometric correction vector is obtained by comparing an image of a gray code test pattern projected by the projection unit with an image of a known gray code test pattern.

4. The image processing apparatus according to claim 1, wherein
the crosstalk correction unit performs the crosstalk correction on the multi-viewpoint images on a basis of a diffusion distribution of each of the multi-viewpoint images.

5. The image processing apparatus according to claim 4, wherein
the crosstalk correction unit performs, from a diffusion distribution in an adjacent viewpoint image in each of the multi-viewpoint images, the crosstalk correction by selectively using a pixel of the viewpoint image affected by diffusion for each position in a horizontal direction in each of the multi-viewpoint images.

6. The image processing apparatus according to claim 5, wherein
the crosstalk correction unit generates, from the diffusion distribution in the adjacent viewpoint image in each of the multi-viewpoint images, a determination distribution for selectively using the pixel of the viewpoint image affected by the diffusion for each position in the horizontal direction in each of the multi-viewpoint images, and performs the crosstalk correction on the multi-viewpoint images on a basis of the determination distribution.

7. The image processing apparatus according to claim 4, wherein
the diffusion distribution is obtained on a basis of an image that is a difference between a test pattern including an all-white image and a test pattern including an all-black image, the test patterns being projected by the projection unit.

8. The image processing apparatus according to claim 1, wherein
the crosstalk correction unit performs the crosstalk correction on the multi-viewpoint images on a basis of a diffusion distribution of each of the multi-viewpoint images subjected to the geometric correction.

9. The image processing apparatus according to claim 1, further comprising
a blurring correction unit that performs blurring correction on the multi-viewpoint images.

10. The image processing apparatus according to claim 9, wherein
the blurring correction unit performs blurring correction on a basis of a point spread function (PSF) in each pixel of the multi-viewpoint images.

11. The image processing apparatus according to claim 10, wherein
the point spread function (PSF) is obtained from an image of a test pattern including one pixel pattern, the image being projected by the projection unit.

12. The image processing apparatus according to claim 9, wherein
the blurring correction unit performs blurring correction on the multi-viewpoint images subjected to geometric correction by the geometric correction unit.

13. The image processing apparatus according to claim 9, wherein
the crosstalk correction unit performs the crosstalk correction on the multi-viewpoint images subjected to geometric correction by the geometric correction unit, and further subjected to blurring correction by the blurring correction unit.

14. The image processing apparatus according to claim 9, wherein
the geometric correction unit performs geometric correction on the multi-viewpoint images subjected to blurring correction by the blurring correction unit.

15. The image processing apparatus according to claim 14, wherein
the crosstalk correction unit performs the crosstalk correction on the multi-viewpoint images subjected to blurring correction by the blurring correction unit, and further subjected to geometric correction by the geometric correction unit.

16. The image processing apparatus according to claim 1, wherein
the projection unit includes a projector array that projects the multi-viewpoint images, a liquid crystal display (LCD), and an organic light emitting diode (OLED).

17. The image processing apparatus according to claim 1, further comprising
a directional screen that diffuses and projects the multi-viewpoint images projected by the projection unit as viewpoint images having directivity.

18. The image processing apparatus according to claim 17, wherein
the directional screen includes a lenticular lens (microlens array), a parallax barrier, and a lens diffuser.

19. An image processing method comprising:
projection processing of projecting multi-viewpoint images;
geometric correction processing of performing geometric correction on the multi-viewpoint images; and
crosstalk correction processing of performing crosstalk correction on the multi-viewpoint images.

20. A program for causing a computer to function as:
a geometric correction unit that performs geometric correction on multi-viewpoint images projected by a projection unit; and
a crosstalk correction unit that performs crosstalk correction on the multi-viewpoint images.
